(19) United States
(12) Patent Application Publication
(10) Pub. No.: US 2026/0292717 A1
(43) Pub. Date: Sep. 24, 2026

(54) OPTIMIZING THE RADIOFREQUENCY POWER OF AN FM RADIO BROADCASTING TRANSMITTER

(71) Applicant: Nautel Limited, Hackett's Cove (CA)

(72) Inventor: Philipp Schmid, Hackett's Cove (CA)

(21) Appl. No.: 19/476,308

(22) PCT Filed: Apr. 17, 2024
(86) PCT No.: PCT/CA2024/050499

§ 371 Date: Oct. 17, 2025

Related U.S. Application Data
(60) Provisional application No. 63/459,833, filed on Apr. 17, 2023.

(51) Int. Cl. H04W 52/36; H04W 52/26

(52) U.S. Cl. CPC H04W 52/367; H04W 52/262

(57) ABSTRACT

The invention relates to a method and a device for optimizing the radiofrequency power of an FM radio broadcasting transmitter by determining mono and stereo modulation content and setting the broadcast transmitter output power level accordingly. The transmitter power output is optimized by identifying whether the modulation content fed into the broadcast exciter is mono or stereo and dynamically adjusting the transmitter power output based on the modulation content. Alternatively, the optimization occurs by processing modulation content fed into the broadcast exciter to generate an MPX signal or mono MPX signal and an encoded power target, followed by a step of placing the MPX signal and the encoded power target on separate channels, and finally decoding the encoded power target to dynamically adjust the transmitter power output. A broadcast exciter with optimized transmitter output is also provided.

### FIELD OF THE INVENTION

The invention relates to optimization of the energy efficiency of broadcasting transmitters. More specifically, the invention relates to a method and a device for optimizing the radiofrequency power of an FM radio broadcasting transmitter by determining mono and stereo modulation content and setting the broadcast transmitter output power level accordingly.

### BACKGROUND OF THE INVENTION

The cost of electricity is ever increasing. Broadcasting transmitters convert AC electric power into emitted RF power at a given efficiency factor. Compared to old style transmitters with lower 50-60% efficiencies the state-of-the-art FM Broadcast transmitters have reached efficiencies in the mid 70% range exhausting potential power savings. Today only little gains can be achieved for broadcasters wanting to reduce their energy costs or carbon footprint. Ultimately, a broadcaster's goal is to deliver their broadcast signal to as many listeners as possible at the lowest cost.

Modulation dependent carrier level (MDCL) has been employed and refined for a long time and is in common use today and shares many high-level concepts with SmartFM technology but largely precedes the SmartFM developments. SmartFM excels in audio segments with high or loud modulation density, but is less effective in low modulation density or bursty segments, such as spoken words.

Adjusting the transmitter power output with modulation bears the risk of reducing the coverage region of the FM broadcast radio station at the fringe where received signal levels are low. When stations are employing multi bay antennas leading to antenna nulls within the core of the coverage region, potential loss of coverage can be experienced in key coverage areas close to the antenna location.

Adjusting the FM transmitter power output in a hybrid FM+In-band on-channel (IBOC) station installation leads to a time varying injection ratio between the FM and IBOC transmitter power output potentially leading to FM host interference from the IBOC carriers. This effect could be encountered on hybrid FM+IBOC amplification using a single transmitter, or high-level and space combined systems using separate transmitters for FM and IBOC.

Additionally, IBOC amplifiers are designed differently from FM amplifiers in that power control in FM is typically achieved by controlling the amplifier supply voltage. IBOC, due to its time varying signal envelope typically employs drive level power control, and thus does not benefit from power reduction in the same way FM does as it comes with a hit in efficiency as power is backed off.

It is known in the industry that changing a FM signal from stereo transmission to monaural audio transmission provides a significant improvement in receiver signal to noise ratio (SNR) providing a larger mono coverage range at the same FM transmitter power output. For example, some broadcasters have reduced the transmitter power output of some of their transmitters while simultaneously switching mono transmission mode statically, e.g. a fixed configuration change not dependent on incoming modulation.

### SUMMARY OF THE INVENTION

A method of optimizing transmitter power output of a broadcast exciter is provided. The method involves a step of identifying whether the modulation content fed into the broadcast exciter is mono or stereo and dynamically adjusting the transmitter power output of the broadcast exciter based on the modulation content identified in the prior step.

Another method of optimizing transmitter power output of a broadcast exciter is provided. The method comprises a step of processing modulation content fed into the broadcast exciter to generate an MPX signal or mono MPX signal and an encoded power target, followed by a step of placing the MPX signal or the mono MPX signal and the encoded power target on separate channels, and finally decoding the encoded power target to dynamically adjust the transmitter power output of the broadcast exciter.

In a further embodiment, a broadcast exciter for transmitting modulation content with optimized transmitter power output is provided. The broadcast exciter may comprise one or more of the following components: a) an audio processor, b) a FM modulator; c) a power target; d) a power control; and e) an amplifier. The one or more components are operationally connected to each other. In certain embodiments a dynamic pilot generator or a dynamic pilot algorithm/carrier is inserted by external means in the audio processor, in a stereo generator or in the FM modulator or a combination thereof that is capable of operating the modulation content to optimize the transmitter power output of the broadcast exciter.

In a further embodiment, a broadcast exciter for transmitting modulation content with optimized transmitter power output is provided. The broadcast exciter may comprise one or more of the following components: a) an audio processor or a power control exciter with a MPX power encoder; b) a FM modulator with a MPX power decoder; c) a power target; d) a power control; e) an amplifier; and f) a dual channel interface. The one or more components are operationally connected to each other. In the above embodiment, the MPX power encoder encodes and the MPX power decoder decodes the modulation content to dynamically optimize the transmitter power output of the broadcast exciter.

### BRIEF DESCRIPTION OF DRAWINGS

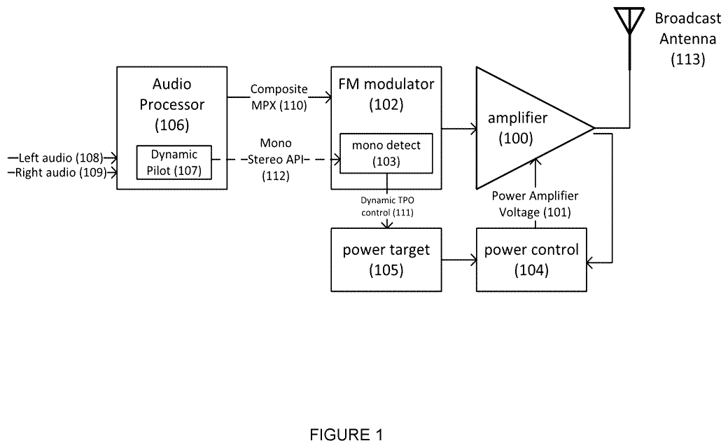

In FIG. 1, the dynamic power control with dynamic mono/stereo generation is shown.

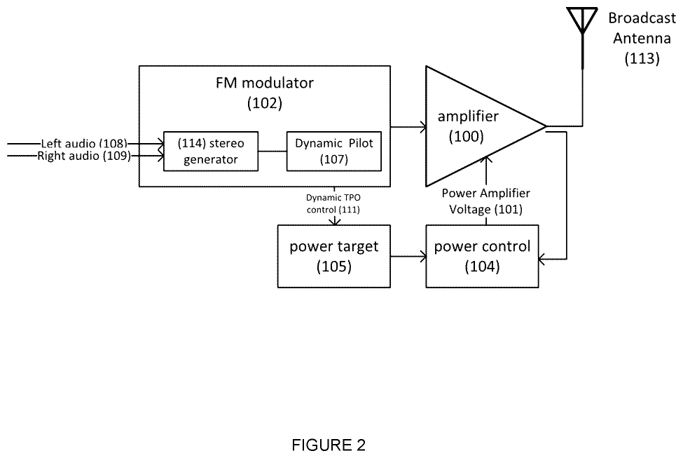

In FIG. 2, the dynamic power control within the broadcast exciter is shown.

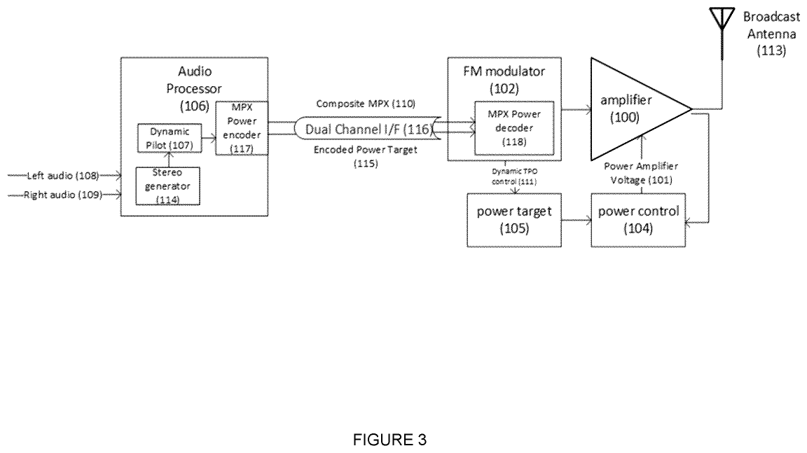

In FIG. 3, an audio processor driving a combined MPX and Encoded Power Target Stream over a Dual Channel Interface is shown.

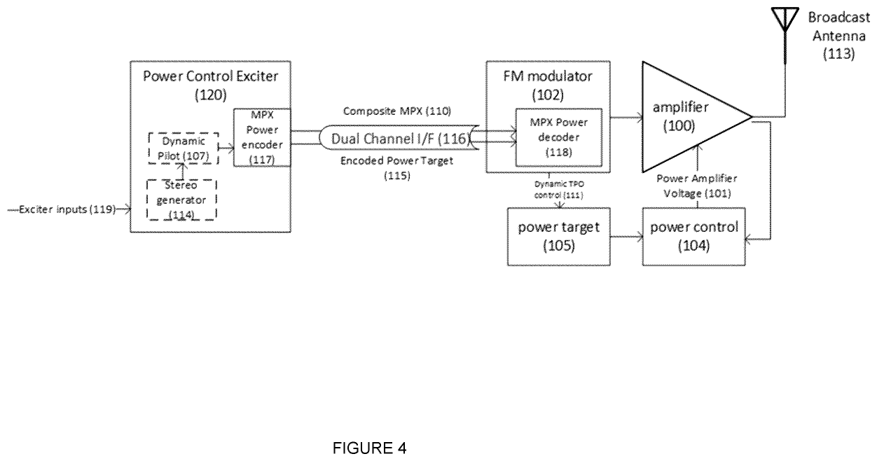

In FIG. 4, a power control exciter driving a combined MPX and Encoded Power Target Stream over a Dual Channel Interface is shown.

### DETAILED DESCRIPTION

The following description is of preferred embodiments by way of example only and without limitation to the combination of features necessary for carrying the invention into effect.

All terms are intended to be understood as they would be understood by a person skilled in the art. Unless defined otherwise, all technical and scientific terms used herein have the same meaning as commonly understood by one of ordinary skill in the art to which the disclosure pertains. The section headings used herein are for organizational purposes only and are not to be construed as limiting the subject matter described.

Although various features of the present disclosure can be described in the context of a single embodiment, the features can also be provided separately or in any suitable combination. Conversely, although the present disclosure can be described herein in the context of separate embodiments for clarity, the present disclosure can also be implemented in a single embodiment.

The following definitions supplement those in the art and are directed to the current application. Accordingly, the terminology used herein is for the purpose of describing particular embodiments only, and is not intended to be limiting.

### Definitions

A “broadcast transmitter” is an electronic device which radiates radio waves modulated with information content intended to be received by the general public. In other words, a transmitter is an electronic device that, with the aid of an antenna, propagates an electromagnetic signal such as radio, or other telecommunication systems. An example is a radio broadcasting transmitter which transmits audio to broadcast radio receivers.

A “broadcast exciter” is a part which contains the oscillator, modulator, and sometimes audio processor, in the broadcasting and telecommunication field. An exciter typically incorporates a power supply, an oscillator, a modulator and amplifiers for audio frequency and radio frequency. The final output of the exciter is given as transmitter power output.

“Transmitter power output” (TPO), in radio transmission, is the actual amount of power (in watts) of radio frequency energy that a transmitter produces at its output. In common parlance, the TPO may also be referred to as “radio frequency power output”.

“Mono and stereo sounds” represent variations of the exact same sound. In the first one, the sound is centered in the middle (mono), and in the second, there are volume variations between left and right (stereo). The difference between monophonic (mono) and stereophonic (stereo) sound is the number of channels used to record and playback audio. Mono signals are recorded and played back using a single audio channel, while stereo sounds are recorded and played back using two audio channels.

“MPX Signal” refers to a stereo multiplexed signal (MPX) which contains multiple components such as the left plus right audio, the left minus right audio, a 19 kHz stereo pilot tone, and a Radio Data System signal. MPX is the composite signal dedicated to the transmitter site. It is the only signal accepted by the transmitter (or exciter) for FM diffusion, and it is traditionally delivered via a point-to-point link.

“Pilot Signal” or “Pilot Tone” in FM stereo broadcasting refers to a pilot tone of 19 kHz which indicates that there is stereophonic information at 38 kHz, alternatively the second harmonic of the pilot tone. The receiver doubles the frequency of the pilot tone and uses it as a frequency and phase reference to demodulate the stereo information.

“IBOC transmission” refers to in-band on-channel (IBOC) transmissions which is a hybrid method of transmitting digital radio and analog radio broadcast signals simultaneously on the same frequency. The name refers to the new digital signals being broadcast in the same AM or FM band (in-band), and associated with an existing radio channel (on-channel). By utilizing additional digital subcarriers or sidebands, digital information is “multiplexed” on existing signals, thus avoiding re-allocation of the broadcast bands. IBOC relies on unused areas of the existing spectrum to send its signals.

“Stereo separation” is the degree of difference between the signals going to the left speaker and to the right speaker.

“Encoder” and “Decoder” refers to a pair of encoder/decoder. The encoder is used for encoding parallel data for transmission feed while reception is decoded by a decoder. Encoders/decoder are used usually to convert some measured parameter into an analogue or digital modulation system that is then transmitted and received.

### Embodiments

In one embodiment, a method of optimizing transmitter power output of a broadcast exciter is provided. The method involves a step of identifying whether the modulation content fed into the broadcast exciter is mono or stereo and dynamically adjusting the transmitter power output of the broadcast exciter based on the modulation content identified in the prior step.

The method may further comprise a step of integrating a dynamic pilot carrier generated by a dynamic pilot generator in the broadcast exciter via external means prior to the step of identifying the modulation content. A dynamic pilot carrier (which is a part of the signal) and the dynamic pilot generator (which creates it or directs a stereo generator to switch between mono and stereo). The dynamic pilot could be inserted in any of the components of the broadcast exciter. In some embodiments, the dynamic pilot is inserted in the audio processor component or in the FM modulator component or a stereo generator of the broadcast exciter.

The dynamic pilot generator measures the stereo difference in the left and right audio of the modulation content or measures the stereo separation to determine whether the modulation content is mono or stereo. In some instances, the dynamic pilot generator operates or modifies the original audio content or the original L/R signal of the modulation content to generate an MPX composite signal by inserting a 19 KHZ pilot tone, L+R audio sum and 38 kHz shifted L−R audio difference if the content is determined to be stereo. The dynamic pilot generator operates on the left/right audio modulation content to generate an MPX signal by inserting a 19 KHZ pilot tone dynamically over time. If the content is determined to be mono, the dynamic pilot generator only inserts the L+R audio sum and does not insert a 19 kHz stereo pilot or the L−R audio difference of a stereo signal to produce mono MPX modulation content or a mono MPX signal. The dynamic pilot generator may adjust audio gains to maximize loudness and overall modulation. If the content is determined to be stereo, the dynamic pilot generator inserts a 19 KHZ pilot tone, L+R audio sum and 38 kHz shifted L−R audio difference or instructs the stereo generator to do so instead.

In certain embodiments, the method further comprises a step of integrating a mono detector in the FM modulator. In some instances, this step can occur before or after the step of integrating the dynamic pilot carrier or algorithm in the audio processor or the FM modulator of the broadcast exciter. The FM modulator or the mono detector therein detects the presence of the 19 KHZ pilot tone in the MPX signal and determines a desired transmitter power output. In other words, the MPX signal generated by the dynamic pilot generator is fed into the FM modulator that detects the presence of the 19 KHZ pilot tone and determines a desired transmitter power output. The mono detector detects the absence of the 19 KHZ pilot tone in the mono MPX modulation content or the mono MPX signal and determines a desired transmitter power output. In other words, the mono MPX signal is fed into the mono detector that detects the absence of the 19 KHZ pilot tone to determine the desired transmitter power output.

In certain embodiments, the method further comprises a step of integrating a stereo generator in the FM modulator. The stereo generator may be inserted before or after integrating the dynamic pilot in the broadcast exciter. The stereo generator converts the incoming modulation content to mono if the content is determined to be stereo. The dynamic pilot generator receives or operates the converted mono and generates the mono MPX signal or mono MPX modulation content by inserting the 19 KHZ pilot tone or additional components noted above. The mono MPX signal or the mono MPX modulation content is fed into the FM modulator or the mono detector therein that detects the presence or absence of the 19 kHZ pilot tone and determines a desired transmitter power output. There is a bit of overlap between the stereo generator and the dynamic pilot generator. The stereo generator always produces an MPX signal, but in mono mode it is only the sum of left plus right. In stereo mode it is L+R, 19 KHZ tone, 38 KHZ shifted L−R difference. However, if signal is mono then L=R; L−R=0.

The desired power output may be communicated with a power control, or the stereo generator, or both to adjust the transmitter power output of the broadcast exciter. In some embodiments, the desired power output is read by the power control, or the stereo generator, or both, resulting in adjustment of the transmitter power output of the broadcast exciter. In certain embodiments, the power control adjusts the transmitter power output by controlling voltage supply to an amplifier until the desired transmitter power output is achieved. In some alternate embodiments, the power control adjusts the transmitter power output until the desired transmitter power output is achieved by: a) controlling voltage supply to an amplifier; b) by controlling the drive level control; or c) by using a control loop with a power slope to reach the desired output to prevent a step function in the transmitter power output.

In certain embodiments, the desired power output is communicated with the power control alone if the MPX signal is received as input. In certain alternative embodiments, the desired power output is communicated with the power control and the stereo generator if the L/R signal is received as input.

In certain embodiments, the method of optimizing the transmitter power output or any of the above-recited steps are carried out via a dynamic control interface using an optimization algorithm. The dynamic control interface facilitates communication between the components of the exciter using the optimization algorithm. In certain embodiments, the dynamic control interface communicates with the audio processor, the FM modulator, the power control, the power target, the amplifier, the mono detector, the stereo generator, or a combination thereof, to optimize the transmitter power output of the exciter.

In certain embodiments, a method of optimizing transmitter power output of a broadcast exciter is provided. The method comprises a step of processing modulation content fed into the broadcast exciter to generate an MPX signal or mono MPX signal and an encoded power target, followed by a step of placing the MPX signal or the mono MPX signal and the encoded power target on separate channels, and finally decoding the encoded power target to dynamically adjust the transmitter power output of the broadcast exciter.

In some embodiments, the step of processing modulation content further comprises a step of receiving the modulation content by an audio processor or a power control exciter, followed by a step of operating the modulation content to generate the MPX signal or the mono MPX signal and finally a step of processing or reading the MPX signal to generate the encoded power target.

In the above embodiments, the step of receiving the modulation content may optionally be carried out by a stereo generator integrated within the audio processor or within the power control exciter. The stereo generator converts the incoming stereo modulation content to mono if the content is determined to be mono. The step of converting the stereo modulation content to mono MPX content or mono MPX signal is explained hereinbefore.

In the above embodiments, the step of operating the modulation content to generate the MPX signal may be carried out by a dynamic pilot generator integrated within the audio processor or within the power control exciter. In such embodiments, the dynamic pilot generator inserts a 19 kHZ pilot tone to the content received from the stereo generator to generate the MPX signal. The dynamic pilot generator measures the stereo difference in the left and right audio of the modulation content or measures the stereo separation to determine whether the modulation content is mono or stereo. In some instances, the dynamic pilot generator operates or modifies the original audio content or the original L/R signal of the modulation content to generate an MPX composite signal by inserting a 19 kHZ pilot tone, L+R audio sum and 38 kHz shifted L−R audio difference if the content is determined to be stereo. The dynamic pilot generator operates on the left/right audio modulation content to generate an MPX signal by inserting a 19 KHZ pilot tone dynamically over time. If the content is determined to be mono, the dynamic pilot generator only inserts the L+R audio sum and does not insert a 19 kHz stereo pilot or the L−R audio difference of a stereo signal to produce mono MPX modulation content or a mono MPX signal. The dynamic pilot generator may adjust audio gains to maximize loudness and overall modulation. If the content is determined to be stereo, the dynamic pilot generator inserts a 19 KHZ pilot tone, L+R audio sum and 38 kHz shifted L−R audio difference or instructs the stereo generator to do so instead.

In the above embodiments, the step of processing or reading the MPX signal to generate the encoded power target may be carried out by an MPX power encoder integrated within the audio processor or within the power control exciter. The MPX power encoder processes the MPX signal to generate the encoded power target.

In certain embodiments, the encoded power target could be an analog voltage level, a digital voltage level or an absolute voltage level.

In certain embodiments, the step of placing the MPX signal and the encoded power target on separate channels may additionally comprise a step of establishing communication between the MPX power encoder and a dual channel interface that places the MPX signal and the encoded power target on separate channels. In such embodiments, the MPX signal and the encoded power target is placed on the left channel and the other is placed on the right channel or both are placed on a discrete channel. The interface can be a standard analog or digital interface standard such as AES/EBU. The dual channel interface is usually based on a standard left/right audio interface.

In some embodiments, the MPX signal or the mono MPX signal is locked in time and is capable of passing through analog to digital conversion, digital to analog conversion, synchronous/asynchronous sample rate conversion or any other conversion process known in the art.

In certain embodiments, the step of decoding the encoded power target to dynamically adjust the transmitter power output of the broadcast exciter may additionally comprise a step of decoding the encoded power target using a MPX power decoder integrated within the FM modulator to determine a desired transmitter power output and then communicating the desired transmitter power output with a power control that dynamically adjusts the transmitter power output.

In certain embodiments, the power control adjusts the transmitter power output by controlling voltage supply to an amplifier until the desired transmitter power output is achieved. In some alternate embodiments, the power control adjusts the transmitter power output until the desired transmitter power output is achieved by: a) controlling voltage supply to an amplifier; b) by controlling the drive level control; or c) by using a control loop with a power slope to reach the desired output to prevent a step function in the transmitter power output.

In some embodiments, the above method or any individual steps may be carried out via a dynamic control interface using an optimization algorithm. The dynamic control interface facilitates communication between the components of the exciter using the optimization algorithm. In some embodiments, the dynamic control interface communicates with the audio processor, the FM modulator, the power control, the power target, the amplifier, the mono detector, the stereo generator, or a combination thereof, to optimize the transmitter power output of the exciter.

In some embodiments, the proposed technique of placing MPX on one channel and a power target on the other channel may be carried out with a SmartFM algorithm or any other broadcasting algorithm known in the art.

In certain embodiments, a broadcast exciter for transmitting modulation content with optimized transmitter power output is provided. The broadcast exciter may comprise one or more of the following components: a) an audio processor, b) a FM modulator; c) a power target; d) a power control; and e) an amplifier. The one or more components are operationally connected to each other. In certain embodiments a dynamic pilot generator or a dynamic pilot algorithm/carrier is inserted by external means in the audio processor, in a stereo generator or in the FM modulator or a combination thereof that is capable of operating the modulation content to optimize the transmitter power output of the broadcast exciter.

Usually, the modulation content is fed into or received by the audio processor or the FM modulator. In those embodiments, the dynamic pilot generator measures stereo separation of the modulation content to determine whether the modulation content is mono or stereo. In some instances, the dynamic pilot generator operates or modifies the original audio content or the original L/R signal of the modulation content to generate an MPX composite signal by inserting a 19 KHZ pilot tone, L+R audio sum and 38 kHz shifted L−R audio difference if the content is determined to be stereo. The dynamic pilot generator operates on the left/right audio modulation content to generate an MPX signal by inserting a 19 KHZ pilot tone dynamically over time. If the content is determined to be mono, the dynamic pilot generator only inserts the L+R audio sum and does not insert a 19 kHz stereo pilot or the L−R audio difference of a stereo signal to produce mono MPX modulation content or a mono MPX signal. The dynamic pilot generator may adjust audio gains to maximize loudness and overall modulation. If the content is determined to be stereo, the dynamic pilot generator inserts a 19 KHZ pilot tone, L+R audio sum and 38 kHz shifted L−R audio difference or instructs the stereo generator to do so instead.

In certain embodiments, the dynamic pilot generator operates the stereo modulation content or the L/R signal of the modulation content to generate an MPX signal by inserting a 19 kHZ pilot tone in the event the modulation content is determined to be stereo. The MPX signal is fed into or received by the FM modulator that detects the presence of the 19 KHZ pilot tone and determines a desired transmitter power output. The FM modulator or the mono detector therein detects the presence of the 19 KHZ pilot tone in the MPX signal and determines a desired transmitter power output. In other words, the MPX signal generated by the dynamic pilot generator in case of stereo content is fed into the FM modulator that detects the presence of the 19 KHZ pilot tone and determines a desired transmitter power output. The mono detector also detects the absence of the 19 KHZ pilot tone in the mono MPX modulation content or the mono MPX signal and determines a desired transmitter power output. In other words, the mono MPX signal is fed into the mono detector that detects the absence of the 19 KHZ pilot tone to determine the desired transmitter power output.

In some embodiments, the dynamic pilot generator retains the original modulation content or the L/R signal of the modulation content or the original mono modulation content in case the modulation content is determined to be mono. The mono MPX signal is fed into a mono detector integrated within the FM modulator that detects the absence of the 19 KHZ pilot tone and determines a desired transmitter power output.

In some embodiments, the FM modulator may additionally comprise a stereo generator that converts the incoming modulation content to mono if the content is determined to be stereo. In such embodiments, the dynamic pilot generator receives or operates on the converted mono modulation content to generate the mono MPX signal without inserting the 19 kHZ pilot tone. The mono MPX signal is then fed into or received by the mono detector in the FM modulator that detects the absence the 19 kHZ pilot tone and determines a desired transmitter power output.

In some embodiments, the desired power output may be communicated with the power control, or the stereo generator, or both, to adjust the transmitter power output of the broadcast exciter. The power control then adjusts the transmitter power output by a) controlling voltage supply to an amplifier; b) by controlling the drive level control; or c) by using a control loop with a power slope to reach the desired output to prevent a step function in the transmitter power output.

In some embodiments, the desired power output is communicated with the power control alone if the MPX signal is received as input. In some alternate embodiments, the desired power output is communicated with the power control and the stereo generator if the mono MPX modulation content or the L/R signal is received as input by the broadcast exciter.

The exciter additionally comprises a dynamic control interface that facilitates communication between the components of the exciter using an optimization algorithm. The dynamic control interface may communicate with the audio processor, the FM modulator, the power control, the power target, the amplifier, the mono detector, the stereo generator, or a combination thereof, to optimize the transmitter power output of the exciter.

In some alternate embodiments, a broadcast exciter for transmitting modulation content with optimized transmitter power output is provided. The broadcast exciter may comprise one or more of the following components: a) an audio processor or a power control exciter with a MPX power encoder; b) a FM modulator with a MPX power decoder; c) a power target; d) a power control; e) an amplifier; and f) a dual channel interface. The one or more components are operationally connected to each other. In the above embodiment, the MPX power encoder encodes and the MPX power decoder decodes the modulation content to dynamically optimize the transmitter power output of the broadcast exciter.

The dynamic pilot generator or the dynamic pilot carrier generated by the dynamic pilot generator may be inserted by external means in the audio processor or the power control exciter is capable of operating the modulation content to optimize the transmitter power output of the broadcast exciter.

The dynamic pilot generator measures the stereo difference in the left and right audio of the modulation content or measures the stereo separation to determine whether the modulation content is mono or stereo. In some instances, the dynamic pilot generator operates or modifies the original audio content or the original L/R signal of the modulation content to generate an MPX composite signal by inserting a 19 KHZ pilot tone, L+R audio sum and 38 kHz shifted L−R audio difference if the content is determined to be stereo. The dynamic pilot generator operates on the left/right audio modulation content to generate an MPX signal by inserting a 19 KHZ pilot tone dynamically over time. If the content is determined to be mono, the dynamic pilot generator only inserts the L+R audio sum and does not insert a 19 kHz stereo pilot or the L−R audio difference of a stereo signal to produce mono MPX modulation content or a mono MPX signal. The dynamic pilot generator may adjust audio gains to maximize loudness and overall modulation. If the content is determined to be stereo, the dynamic pilot generator inserts a 19 KHZ pilot tone, L+R audio sum and 38 kHz shifted L−R audio difference or instructs the stereo generator to do so instead.

The FM modulator or the mono detector therein detects the presence of the 19 kHZ pilot tone in the MPX signal and determines a desired transmitter power output. In other words, the MPX signal generated by the dynamic pilot generator is fed into the FM modulator that detects the presence of the 19 KHZ pilot tone and determines a desired transmitter power output. The mono detector detects the absence of the 19 KHZ pilot tone in the mono MPX modulation content or the mono MPX signal and determines a desired transmitter power output. In other words, the mono MPX signal is fed into the mono detector that detects the absence of the 19 KHZ pilot tone to determine the desired transmitter power output.

In certain embodiments, the audio processor or the power control exciter may additionally have a stereo generator. The stereo generator converts the modulation content to mono and feeds it into or provides to the dynamic pilot generator if the modulation content is stereo. The conversion process is as recited and explained hereinbefore.

In certain embodiments, the dynamic pilot generator mutes a 19 KHZ pilot tone on the MPX modulation content received from the stereo generator to generate a new mono MPX signal if the signal is determined to be mono. The gain on the MPX signal may be adjusted to maximize loudness or modulation level. The MPX signal is then processed by the MPX power encoder to generate an encoded power target. In some embodiments, the encoded power target may be an analog voltage level, a digital voltage level or an absolute voltage level.

In some embodiments, the dual channel interface places the MPX signal or the mono MPX signal on one channel and the encoded power target on another channel. In certain embodiments, one of the MPX signal or the mono MPX signal and the encoded power target is placed on the left channel and the other is placed on the right channel or both are placed on a discrete channel.

In certain embodiments, the MPX signal or the mono MPX signal is locked in time and is capable of passing through analog to digital conversion, digital to analog conversion, synchronous/asynchronous sample rate conversion or any other conversion process known in the art.

In the above embodiments, the MPX power decoder in the FM modulator decodes the encoded power target to determine a desired transmitter power output. The FM modulator communicates the desired transmitter power output with the power control and the power control dynamically adjusts the transmitter power output. In some embodiments, the power control adjusts the transmitter power output until the desired transmitter output is achieved. In certain embodiments, the power control adjusts the transmitter power output by controlling voltage supply to the amplifier.

In certain embodiments, the exciter additionally comprises a dynamic control interface that facilitates communication between the components of the exciter using an optimization algorithm. The dynamic control interface may communicate with the audio processor, the FM modulator, the power control, the power target, the amplifier, the mono detector, the stereo generator, or a combination thereof, to optimize the transmitter power output of the exciter.

In some embodiments, the exciter is combined with a SmartFM algorithm or any other broadcasting algorithm known in the art.

In some embodiments, a broadcasting system with optimized transmitter power output comprising the broadcast exciter described hereinbefore is provided.

In some embodiments, an apparatus for optimizing a broadcasting operation substantially as described with reference to the drawings is provided.

In some embodiments, a method of optimizing a broadcasting operation substantially as described with reference to the drawings.

### Proposed Techniques and Implementations

New algorithms are emerging that focus on reducing the transmitter power set point intelligently based on audio and data modulation input while striving to maintain best possible transmitter efficiency. One such algorithm was introduced by WorldCast™ systems dubbed SmartFM™ that adjusts the transmitter power output based on an analysis of the modulation signal content. For example, if rock music is played with heavy modulation density the transmitter power can be reduced on the premise that any added noise build up in the receiver due to a lower signal to noise ratio is masked perceptually by the apparent loudness of the audio. However, when classical music is played, in the silence or spoken word segments, the power output is restored closer to the original setpoints. This approach is similar to the modulation dependent carrier level (MDCL) control employed on AM broadcast transmitters.

Audio processor implementations exist for FM and other applications that can intelligently analyze the incoming audio content to dynamically change the composite FM MPX modulation content to either be monaural or stereo based on the left/right (L/R) stereo separation or stereo difference in the left and right audio. In the event, stereo is enabled the audio processor adds the 19 kHz pilot tone to the left+right audio sum and the 38 KHz frequency shifted left−right audio difference to generate the composite MPX spectrum, whereas, in mono mode only the left+right component remains. A number of parameters can adjust the decision to switch between mono and stereo.

It is pertinent to note that the signal to noise ratio (SNR) improvements are optimally leveraged if the audio processor uses the mono overhead to its maximum potential and processes the signal as mono and not simply turn off the stereo component. FM signals with monoaural modulation exhibit a stronger signal-to-noise ratio and can achieve similar coverage at a lower power level compared to stereo signals at higher power levels. Therefore, energy efficiency can be optimized without impacting coverage by dynamically broadcasting mono or stereo composite MPX signals based on the input modulation. The present innovation is independent of modulation density and can complement prior technologies.

In the present invention, the transmitter power output is dynamically being adjusted based on the content being mono or stereo. In one embodiment, this is achieved by detecting the presence of the 19 kHz pilot in the incoming MPX signal in the broadcast exciter, wherein the incoming MPX signal is an analog MPX, a digital MPX, MPX over IP or any other form of MPX delivery known in the art. After detecting the pilot tone, the transmitter power output target is adjusted by allowing power control to settle on the desired transmitter power output. In certain embodiments, the pilot can be inserted dynamically via external means as shown in FIG. 1.

In some alternate embodiments, the transmitter power output is dynamically adjusted based on the content being mono or stereo by interfacing with an audio processor via a control API or similar method to determine the dynamic mono or stereo content using an internal algorithm. If the input to the exciter is determined to be composite MPX, only the power control's transmitter power output (TPO) target needs to be adjusted. However, if the input is L/R audio or another means, the internal exciter stereo generator also needs to be configured in accordance along with the transmitter power output target as shown in FIG. 1.

In some alternate embodiments, the transmitter power output is dynamically adjusted based on the content being mono or stereo by determining the stereo separation of the L/R audio within the broadcast exciter, dynamically changing the stereo generator and adjusting the transmitter power output target by allowing power control to settle on the desired transmitter power output as shown in FIG. 2. The dynamic mono and stereo algorithm noted above may also be applied to L/R or MPX audio.

FIG. 1 shows the dynamic power control with dynamic mono/stereo generation. As shown in the figure, left audio (108)/right audio (109) are presented to an audio processor that operates on the audio content and produces a composite MPX signal (110) or mono stereo API (112) based on an algorithm for dynamic pilot insertion (107) that measures stereo separation to determine mono or stereo mode. The FM modulator (102) takes the MPX signal (110) to perform FM modulation and upconversion to the carrier frequency and passes it to the amplifier (100) and on to the broadcast antenna (113).

In certain embodiments, the FM modulator can have a mono detector to detect the 19 kHz pilot tone and setting a power target (105) through a dynamic transmitter power output control interface (111). In some embodiments, power control (104) can set and drive the amplifier supply voltage (101) to control the gain and power level of the amplifier (100) until the desired output power level is read by the power control (104). The dynamic pilot (107) algorithm is a software algorithm that determines or measures the stereo difference in the left and right audio (stereo separation). In certain alternate embodiments, a stereo generator (114) and the dynamic pilot generation (107) algorithm could be incorporated into the FM modulator block (102) as shown in FIG. 2.

FIG. 3 depicts a novel dual channel interface (116) definition that places the composite signal (110) as defined and explained earlier on one audio channel (e.g. left) and an encoded power target (115) stream on another channel (e.g. right). It is pertinent to note that the encoded power stream (115) is distinct from the mono stereo API (112) shown in FIG. 1. The power stream (115) represents a time varying encoded power target stream rather than a discrete API that among other options could be used for the mono stereo API (112). In some embodiments, this implementation requires an MPX power encoder or an encoder block (117) in the sender and an MPX power decoder or a decoder block (118) in the receiver.

FIG. 4 demonstrates the agnostic nature of a dual channel interface (116) definition as nothing on the transmitter side changes and only the audio processor (106) of FIG. 3 is replaced with a power control exciter (120). The power control exciter (120) can be a stripped-down exciter with typical exciter inputs (119) with an optional stereo generator (114) and optional dynamic pilot (107).

In certain embodiments, the proposed power control application programming interface (API) may be combined with the MPX content. Commonly, MPX signals are fed into or received by the broadcast exciter using a stereo input method, such as digital AES. Since composite MPX is only a single signal channel stream, unlike stereo audio that is a dual channel stream, the MPX signal can be placed on the left channel and power control can be placed on the right channel or each may be placed on any discrete channel. The power control can be encoded as an analog voltage level with respect to a reference voltage or it can be encoded digitally with respect to a full-scale definition representing 100% power or an absolute power level.

An encoder block (117) shown in FIGS. 3 and 4 performs translation of the desired power level to the appropriate digital or analog voltage level; a decoder takes the incoming voltage or digital level and translates it into a percentage power set point or an absolute power setpoint in Watts. This approach is advantageous because the MPX is locked to the power control stream in time and can be passed through analog to digital conversion, digital to analog conversion, and synchronous/asynchronous digital sample rate conversion and any other similar process without significant loss of content and control information.

In some alternate embodiments, by defining a combined MPX and power control interface an exciter design agnostic to the underlying power control algorithm can be created and applied to the presented mono/stereo algorithm or other algorithms like SmartFM or combinations of algorithms. Thus, an exciter that is non-encumbered with nor beholden to either algorithm can be devised as shown in FIGS. 3 and 4.

In order to achieve the target TPO level, several methods can be used, for instance, controlling the amplifier supply voltage or controlling the drive level control. Since, supply voltage affects the amplifier gain it can be employed to control the transmitter power output (TPO), alternatively, the input level to the amplifier can be adjusted to affect the output of the amplifier. In certain embodiments, any other methods and implementations known in the art may also be used. For instance, a control loop with a power slope to reach the target could be used to prevent a step function in the transmitter power output. This can be achieved by using the various implementation methods known in the art.

In some embodiments, the presented combination of dynamic mono/stereo operation techniques with transmitter power output (TPO) control could be combined with the patented SmartFM algorithm to further improve FM power savings as both algorithms improve in different segments of the broadcast signal. However, it is pertinent to note that the proposed method is completely independent and de-coupled from the SmartFM algorithm. For example, if SmartFM reduces power consumption by 30% on rock content but 25% of the station format is spoken word the overall reduction is closer to 22.5%. Since the spoken word content is captured via mono microphone, our method could reduce 25% of the time by as much as 50% or more; another 12.5% for a combined 35% savings. In certain embodiments, overnight programming or off-peak programming could also be done in mono to conserve vast amounts of power.

Unlike the SmartFM algorithm, the proposed technique, mono/stereo method and the dynamic pilot algorithm can be employed with the hybrid FM+IBOC transmission, since the inherent SNR resilience of mono transmission hardens the FM signal against IBOC to FM host interference. Since the hybrid FM+IBOC signal contains both the IBOC and the FM a simple power control method is no longer applicable since the power of the IBOC carriers must stay constant. Instead, the ratio between the FM and IBOC power levels could be adjusted (injection ratio) such that the FM power follows the intended target power while the IBOC power stays constant.

In certain embodiments, any power target can be set using the proposed technique without limitations. Typically the power target with mono transmission is lower than that of stereo transmission but generally any power target could be set.

### Examples

A radio station with a mix of music and spoken word could benefit greatly from this invention. As rock or pop music with a high degree of stereo difference is played, the dynamic pilot (107) algorithm would keep the broadcast in stereo mode and high power. The DJ's spoken word would typically be recorded in a monoaural microphone causing the dynamic pilot (107) to be switched into mono mode at reduced TPO.

Another example is a news or sports station that predominantly runs with mono content. Such stations can save power during regular programming. During commercial breaks, stereo adverts could be configured to trigger automatic stereo mode at high power levels for a superior broadcast which can possibly be offered at a premium spot price.

As would be appreciated by a person skilled in the art, one or more illustrative embodiments have been described by way of example only. It will be understood to persons skilled in the art that a number of variations and modifications can be made without departing from the scope of the invention as defined in the claims.

All citations and/or references recited herein are hereby incorporated by reference in their entirety.

### References:

[1] METHOD AND DEVICE FOR OPTIMIZING THE RADIOFREQUENCY POWER OF AN FM RADIO BROADCASTING TRANSMITTER—FR3058013B1
[2] Vernier, Doug, “The looming danger of host interference with −10 dBc IBOC injection.” https://www.v-soft.com/wp-content/uploads/2012/04/The-looming-danger-of-host-interference-with.pdf
[3] Irwin, Doug, “There's an Art to On-Air Processing” (https://www.radioworld.com/industry/theres-an-Art-to-onair-processing)
[4] Articles on “broadcasting”, “transmitter”, “exciter”, “transmitter power output”, “MPX signal”, “Mono and Stereo sounds”, “IBOC transmission”, “Encoder”, “Decoder”, and “Stereo separation” on Wikipedia

1. A method of optimizing transmitter power output of a broadcast exciter by:
a) identifying whether the modulation content fed into the broadcast exciter is mono or stereo;
b) dynamically adjusting the transmitter power output based on the modulation content identified in step a).

2. The method of claim 1, wherein the method further comprises a step of:
c) inserting a dynamic pilot carrier generated by a dynamic pilot generator into the modulation content fed into the broadcast exciter via external means prior to step a).

3. The method of claim 2, wherein the dynamic pilot carrier is inserted in an audio processor, in an FM modulator, or in a stereo generator of the broadcast exciter.

4. The method of claim 3, wherein the dynamic pilot carrier measures the stereo difference in the left and right audio of the modulation content or measures the stereo separation to determine whether the modulation content is mono or stereo.

5. The method of claim 4, wherein the dynamic pilot generator operates on the L/R stereo modulation content to generate an MPX signal by inserting a 19 kHZ pilot tone, the audio sum and 38 KHz frequency shifted audio difference, if the content is determined to be stereo.

6. The method of claim 4, wherein the dynamic pilot generator produces mono MPX modulation content comprised of the left plus right audio sum if the content is determined to be mono.

7. The method of any one of claims 2-6, wherein the method further comprises a step of:
d) integrating a mono detector in the FM modulator.

8. The method of claim 7, wherein the mono detector in the FM modulator detects the presence of the 19 kHZ pilot tone in the MPX signal and determines a desired transmitter power output.

9. The method of claim 7, wherein the mono detector in the FM modulator detects the absence of the 19 KHZ pilot tone in the mono MPX modulation content and determines a desired transmitter power output.

10. The method of any one of claims 2-6, wherein the method further comprises a step of:
d) integrating a stereo generator in the FM modulator.

11. The method of claim 10, wherein the stereo generator converts the incoming modulation content to mono if the content is determined to be stereo.

12. The method of claim 11, wherein the dynamic pilot operates on the incoming stereo modulation content to generate the mono MPX modulation content without inserting a 19 KHZ pilot tone.

13. The method of claim 12, wherein the FM modulator detects the absence of the 19 KHZ pilot tone in the mono MPX modulation content and determines a desired transmitter power output.

14. The method of any one of claims 8-13, wherein the desired power output is communicated with a power control, or the stereo generator, or both to adjust the transmitter power output of the broadcast exciter.

15. The method of claim 14, wherein the power control adjusts the transmitter power output until the desired transmitter power output is achieved by: a) controlling voltage supply to an amplifier; b) by controlling the drive level control; or c) by using a control loop with a power slope to reach the desired output to prevent a step function in the transmitter power output.

16. The method of claim 14, wherein the desired power output is communicated with the power control alone if the MPX signal is received as input.

17. The method of claim 14 wherein the desired power output is communicated with the power control and the stereo generator if the mono MPX modulation content is received as input.

18. The method of any one of claims 1-17, wherein the method or steps thereof are carried out via a dynamic control interface using an optimization algorithm.

19. The method of any one of claims 1-18, wherein the dynamic control interface facilitates communication between the components of the exciter using the optimization algorithm.

20. The method of any one of claims 1-19, wherein the dynamic control interface communicates with the audio processor, the FM modulator, the power control, the power target, the amplifier, the mono detector, the stereo generator, or a combination thereof, to optimize the transmitter power output of the exciter.

21. A method of optimizing transmitter power output of a broadcast exciter by:
a) processing modulation content fed into the broadcast exciter to generate an MPX signal or a mono MPX signal and an encoded power target;
b) placing the MPX signal and the encoded power target on separate channels, and
c) decoding the encoded power target to dynamically adjust the transmitter power output of the broadcast exciter.

22. The method of claim 21, wherein step a) further comprises:
d) receiving the modulation content by an audio processor or a power control exciter;
e) operating the modulation content to generate the MPX signal; and
f) reading the MPX signal to generate the encoded power target.

23. The method of claim 22, wherein step d) is carried out by a stereo generator integrated within the audio processor or within the power control exciter that converts the L/R modulation content to mono if the content is determined to be stereo.

24. The method of claim 22, wherein step e) is carried out by a dynamic pilot carrier generated by a dynamic pilot generator integrated within the audio processor or within the power control exciter that inserts a 19 KHZ pilot tone, the audio sum and 38 KHz frequency shifted audio difference if the modulation content is determined to be stereo to generate a new MPX signal; or the dynamic pilot generator produces mono MPX signal comprised of the left plus right audio sum without the 19 KHZ pilot tone if the content is determined to be mono.

25. The method of clam 22, wherein step f) is carried out by an MPX power encoder integrated within the audio processor or within the power control exciter that processes the MPX signal or the mono MPX signal to generate the encoded power target.

26. The method of any one of claims 21-26, wherein the encoded power target is an analog voltage level, a digital voltage level or an absolute voltage level.

27. The method of claim 26, wherein step b) additionally comprises:
h) establishing communication between the MPX power encoder and a dual channel interface that places the MPX signal and the encoded power target on separate channels, wherein the dual channel interface is based on a standard left/right audio interface.

28. The method of claim 27, wherein one of the MPX signal and the encoded power target is placed on the left channel and the other is placed on the right channel or both are placed on a discrete channel.

29. The method of claim 27, wherein the MPX signal is locked in time and is capable of passing through analog to digital conversion, digital to analog conversion, synchronous/asynchronous sample rate conversion or any other conversion process known in the art.

30. The method of claim 27, wherein step c) additionally comprises:
i) decoding the encoded power target using a MPX power decoder integrated within the FM modulator to determine a desired transmitter power output;
j) communicating the desired transmitter power output with a power control that dynamically adjusts the transmitter power output.

31. The method of claim 30, wherein the power control adjusts the transmitter power output until the desired transmitter output is achieved by a) controlling voltage supply to an amplifier; b) by controlling the drive level control; or c) by using a control loop with a power slope to reach the desired output to prevent a step function in the transmitter power output.

32. The method of any one of claims 21-31, wherein the method or steps thereof are carried out via a dynamic control interface using an optimization algorithm.

33. The method of any one of claims 32, wherein the dynamic control interface facilitates communication between the components of the exciter using the optimization algorithm.

34. The method of any one of claims 33, wherein the dynamic control interface communicates with the audio processor, the FM modulator, the power control, the power target, the amplifier, the mono detector, the stereo generator, or a combination thereof, to optimize the transmitter power output of the exciter.

35. The method of claim 27, wherein the method is carried out with a SmartFM algorithm or any other broadcasting algorithm known in the art.

36. A broadcast exciter for transmitting modulation content with optimized transmitter power output comprising following components:
a) an audio processor,
b) a FM modulator;
c) a power target;
d) a power control; and
e) an amplifier
wherein the components are operationally connected to each other;
wherein a dynamic pilot carrier generated by a dynamic pilot generator is inserted by external means in the audio processor, in the FM modulator or both that operates on the modulation content to optimize the transmitter power output of the broadcast exciter.

37. The broadcast exciter of claim 36, wherein the modulation content is received by the audio processor or the FM modulator.

38. The exciter of claim 37, wherein the dynamic pilot carrier measures the stereo difference in the left and right audio of the modulation content or measures stereo separation to determine whether the modulation content is mono or stereo.

39. The exciter of claim 38, wherein the dynamic pilot generator operates on the L/R stereo modulation content to generate an MPX signal by inserting a 19 kHZ pilot tone, the audio sum and 38 KHz frequency shifted audio difference if the content is determined to be stereo.

40. The exciter of claim 38, wherein the dynamic pilot produces a mono MPX modulation content comprised of the left plus right audio sum without a 19 kHz pilot tone if the modulation content is determined to be mono

41. The exciter of claim 39, wherein a mono detector in the FM modulator detects the presence of the 19 kHZ pilot tone in the MPX signal and determines a desired transmitter power output.

42. The exciter of claim 40, wherein the mono detector integrated in the FM modulator detects the absence of the 19 kHZ pilot tone in the mono MPX modulation content and determines a desired transmitter power output.

43. The exciter of claim 42, wherein the FM modulator additionally comprises a stereo generator that converts the incoming modulation content to mono if the content is determined to be stereo.

44. The exciter of claim 43, wherein the dynamic pilot operates on the converted mono modulation content to generate the mono MPX modulation content without inserting the 19 KHZ pilot tone.

45. The exciter of claim 44, wherein mono detector in the the FM modulator detects the absence of the 19 kHZ pilot tone in the mono MPX modulation content and determines a desired transmitter power output.

46. The exciter of any one of claims 41-45, wherein the desired power output is communicated with the power control, or the stereo generator, or both to adjust the transmitter power output of the broadcast exciter.

47. The exciter of claim 46, wherein the power control adjusts the transmitter power output by: a) controlling voltage supply to an amplifier; b) by controlling the drive level control; or c) by using a control loop with a power slope to reach the desired output to prevent a step function in the transmitter power output.

48. The exciter of claim 46, wherein the desired power output is communicated with the power control alone if the MPX signal is received as input.

49. The exciter of claim 46, wherein the desired power output is communicated with the power control and the stereo generator if the mono MPX modulation content is received as input.

50. The exciter of any one of claims 29-39, wherein the exciter additionally comprises a dynamic control interface that facilitates communication between the components of the exciter using an optimization algorithm.

51. The exciter of any one of claims 36-50, wherein the dynamic control interface communicates with the audio processor, the FM modulator, the power control, the power target, the amplifier, the mono detector, the stereo generator, or a combination thereof, to optimize the transmitter power output of the exciter.

52. A broadcast exciter for transmitting modulation content with optimized transmitter power output comprising following components:
a) an audio processor or a power control exciter with a MPX power encoder,
b) a FM modulator with a MPX power decoder;
c) a power target;
d) a power control;
e) an amplifier; and
f) a dual channel interface;
wherein the components are operationally connected to each other;
wherein the MPX power encoder encodes and the MPX power decoder decodes the modulation content to dynamically optimize the transmitter power output of the broadcast exciter.

53. The broadcast exciter of claim 52, wherein a dynamic pilot carrier generated by a dynamic pilot generator is inserted by external means in the audio processor or the power control exciter that operates on the modulation content to optimize the transmitter power output of the broadcast exciter, wherein the dynamic pilot carrier measures the stereo difference in the left and right audio of the modulation content or measures the stereo separation to determine whether the modulation content is mono or stereo.

54. The broadcast exciter of claim 52, wherein the audio processor or the power control exciter additionally comprises a stereo generator.

55. The broadcast exciter of claim 54, wherein the stereo generator converts the incoming stereo modulation content to mono and provides it to the dynamic pilot carrier if the modulation content is stereo.

56. The broadcast exciter of claim 55, wherein the dynamic pilot generator operates on the the L/R stereo modulation content to generate the MPX signal by inserting a 19 KHZ pilot tone, the audio sum and 38 KHz frequency shifted audio difference if the content is determined to be stereo; or produces mono MPX signal comprised of the the left plus right audio sum if the content is determined to be mono.

57. The broadcast exciter of claim 56, wherein the MPX power encoder processes the MPX signal or the mono MPX signal generated by the dynamic pilot generator to determine an encoded power target.

58. The broadcast exciter of claim 57, wherein the encoded power target is an analog voltage level, a digital voltage level or an absolute voltage level.

59. The broadcast exciter of claim 58, wherein the dual channel interface places the MPX signal on one channel and the encoded power target on another channel, wherein the dual channel interface is based on a standard left/right audio interface.

60. The broadcast exciter of claim 59, wherein one of the MPX signal and the encoded power target is placed on the left channel and the other is placed on the right channel or both are placed on a discrete channel.

61. The broadcast exciter of claim 60, wherein the MPX signal is locked in time and is capable of passing through analog to digital conversion, digital to analog conversion, synchronous/asynchronous sample rate conversion or any other conversion process known in the art.

62. The broadcast exciter of any one of the claims 52-61, wherein the MPX power decoder in the FM modulator decodes the encoded power target to determine a desired transmitter power output.

63. The broadcast exciter of claim 62, wherein the FM modulator communicates the desired transmitter power output with the power control, which dynamically adjusts the transmitter power output.

64. The exciter of claim 63, wherein the power control adjusts the transmitter power output until the desired transmitter output is achieved.

65. The exciter of claim 64, wherein the power control adjusts the transmitter power output by a) controlling voltage supply to an amplifier; b) by controlling the drive level control; or c) by using a control loop with a power slope to reach the desired output to prevent a step function in the transmitter power output.

66. The broadcast exciter of any one of claims 52-65, wherein the exciter additionally comprises a dynamic control interface that facilitates communication between the components of the exciter using an optimization algorithm.

67. The exciter of any one of claims 52-66, wherein the dynamic control interface communicates with the audio processor, the FM modulator, the power control, the power target, the amplifier, the mono detector, the stereo generator, or a combination thereof, to optimize the transmitter power output of the exciter.

68. The exciter of any one of claims 36-67, wherein the exciter is combined with a SmartFM algorithm or any other broadcasting algorithm known in the art.

69. A broadcasting system with optimized transmitter power output comprising the broadcast exciter according of any one of claims 36-67.

70. An apparatus for optimizing a broadcasting operation substantially as described with reference to the drawings.

71. A method of optimizing a broadcasting operation substantially as described with reference to the drawings.
